(19) United States
(12) Patent Application Publication
(10) Pub. No.: US 2005/0229224 A1
(43) Pub. Date: Oct. 13, 2005

(54) Information processing device and information processing system

(75) Inventors: Toshiko Matsumoto, Yokohama (JP); Tamotsu Ito, Ayase (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/927,664

(22) Filed: Aug. 26, 2004

(30) Foreign Application Priority Data
Mar. 31, 2004 (JP) 2004-102110

(51) Int. Cl. H04N 7/173; G06F 13/00; H04N 5/445; H04N 7/16

(52) U.S. Cl. 725/100; 348/725; 725/131; 725/139; 725/151

(57) ABSTRACT

Heretofore, a received broadcast program is only displayed just as it is, and therefore it is not possible to change the broadcast program itself in response to each user's preference. In order to achieve the above-mentioned object, according to one aspect of the present invention, there is provided an information processing device capable of receiving a television broadcast, the information processing device including: a broadcast receiving unit for receiving a television broadcast; a display unit for displaying an image of the television broadcast received by the broadcast receiving unit; an input unit for inputting a keyword; a storage unit for storing the keyword, and data associated with the keyword; and a control unit for controlling the broadcast receiving unit, the display unit, the input unit, and the storage unit; wherein if the keyword is included in the television broadcast received by the broadcast receiving unit, said control unit controls the display unit so that the image of the television broadcast and the data associated with the keyword are combined before displaying the image and the data.

### CLAIM OF PRIORITY

The present application claims priority from Japanese application serial no. P2004-102110, filed on Mar. 31, 2004, the content of which is hereby incorporated by reference into this application.

### BACKGROUND OF THE INVENTION

The present invention relates to an information processing device and an information processing system. The present invention relates to, for example, an information processing device capable of receiving a broadcast signal, television sets, cellular phones having a broadcast signal receiving function, PHS (Personal Handy-Phone System), PDA (Personal Digital Assistant), PC (Personal Computer), and the like.

Heretofore, as a function for controlling television programs by keywords registered by a user, there is proposed the technique whereby as a result of monitoring whether a program related to an inputted keyword is being broadcasted, if such a program is being broadcasted, the program is presented, or contents of the program is recorded (for example, Japanese Patent Laid-Open No. 2002-300485 (patent document 1).

In addition, there is proposed the technique whereby if a user stores in advance his/her taste information in a image viewing device or a server, attribute information is added to each program on the program provider side, and a program most satisfying user's taste is determined according to the taste information of the user (for example, Japanese Patent Application Laid-Open No. 2003-289481 (patent document 2)).

However, the techniques according to the related art only displays a received broadcast program just as it is, and therefore it is not possible to change or customize the broadcast program itself in response to user's preference. For example, even when a specific cast (for example, a sport player) appears on a broadcast program, or when a specific scene (for example, a scene of scoring a point) occurs, it is not possible to enhance the presence, and to produce a realistic atmosphere, by combining an image, audio, characters, and the like, with the broadcast program before they are displayed on a screen.

### SUMMARY OF THE INVENTION

According to one aspect of the present invention, there is provided an information processing device capable of receiving a television broadcast, said information processing device including:
a broadcast receiving unit for receiving a television broadcast;
a display unit for displaying an image of the television broadcast received by the broadcast receiving unit;
an input unit for inputting a keyword;
a storage unit for storing the keyword, and data associated with the keyword; and
a control unit for controlling the broadcast receiving unit, the display unit, the input unit, and the storage unit.

If the keyword is included in the television broadcast received by the broadcast receiving unit, said control unit controls the display unit so that the image of the television broadcast and the data associated with the keyword are combined before displaying the image and the data.

This makes it possible to provide an information processing device, and an information processing system, capable of further entertaining users in response to user's preference.

### BRIEF DESCRIPTION OF THE DRAWINGS

These and other features, objects and advantages of the present invention will become more apparent from the following description when taken in conjunction with the accompanying drawings wherein

FIG. 1 is a configuration diagram illustrating an information display apparatus according to a first embodiment;

FIG. 2 is a flowchart illustrating processing steps according to the first embodiment;

FIG. 3 is a flowchart illustrating processing steps according to the first embodiment;

FIG. 4 is a drawing illustrating display screen images according to the first embodiment;

FIG. 5 is a configuration diagram illustrating an information display apparatus and an information delivery device according to a second embodiment;

FIG. 6 is a flowchart illustrating processing steps according to the second embodiment; and

FIG. 7 is a list of registered keywords according to the first and second embodiments.

### DETAILED DESCRIPTION OF THE PREFERRED EMBODIMENTS

### First Embodiment

To begin with, a first embodiment will be described. The first embodiment will be first outlined. In this embodiment, a user registers a specific keyword in advance. When the keyword is detected from a received broadcast signal, then an image, audio, characters, and the like, are combined with a broadcast program before they are displayed on a screen. For example, when a specific cast (for example, a sport player) appears on a broadcast program, or when a specific scene (for example, a scene of scoring a point) occurs, an image, audio, characters, and the like, which are appropriate to the cast and the scene, are combined with a broadcast program, and then the combined broadcast program is displayed on a screen. For example, image of the television broadcast and image data associated with the keyword are displayed on the same screen. As a result, it becomes possible to enhance the presence and to produce a realistic atmosphere, which makes it possible to provide an information processing device, and an information processing system, capable of further entertaining users. The first embodiment will be described in detail as below.

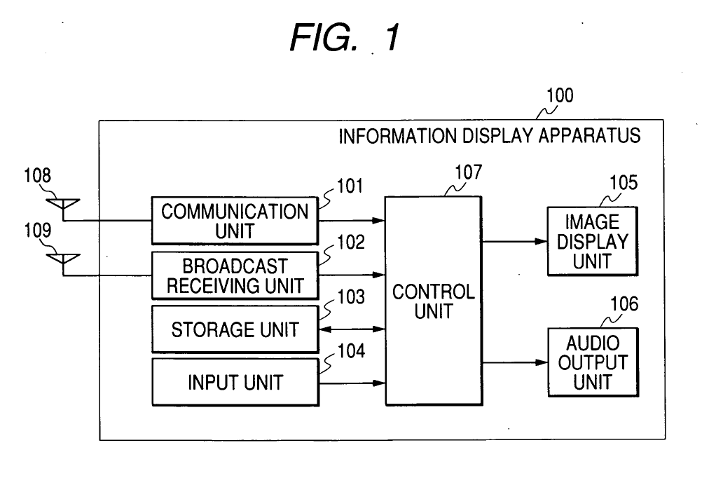

FIG. 1 is a diagram illustrating components of an information display apparatus 100 as an information processing device according to this embodiment. The information display apparatus 100 includes: a communication unit 101 for communicating with other terminals, external devices outside the terminals, and the like, through an antenna 108; a broadcast receiving unit 102 for receiving, through the antenna 109, broadcasts including television broadcasts and radio broadcasts; a storage unit 103 for storing audio data including audio and music as well as image data including a still image and a moving image; an input unit 104 through which audio and an image are inputted, and through which the operation is performed; an image display unit 105 for displaying character data and image data; an audio output unit 106 for outputting audio data; and a control unit 107 for controlling the above-mentioned units.

The communication unit 101 communicates with other information display apparatuses and external devices through the antenna 108. This enables users to make a telephone conversation and exchange communications (electronic mail, Web). Here, it should be noted that although the information display apparatus 100 is configured to have the communication unit in the first embodiment, it may also be configured not to have the communication unit.

The broadcast receiving unit 102 receives through the antenna 109 a broadcast signal delivered from a broadcasting station. The broadcast signal includes not only image data, and audio data, of the broadcast program, but also information data about the broadcast program. The information data about the broadcast program includes, for example, program information such as EPG data. To be more specific, the information data includes: a program name of the program to be broadcasted; the start time, and the end time, of the program; a cast name; a cast name that is currently being displayed; a genre of the program; an outline of the program; and a status, and contents, which are currently being displayed. The users can view the program with the image data and the audio data included in the broadcast signal being output by use of the image display unit, or the audio output unit, which will be described below. It is to be noted that although the received broadcast is usually a television broadcast, it may also be possible to receive a radio broadcast, or a data broadcast, which does not include image data. In addition, a signal is received through the antenna in this embodiment. However, as is the case with a cable television broadcast, or the like, a signal may also be received without using an antenna.

The storage unit 103 includes, for example, a ROM (Read Only Memory), and a RAM (Random Access Memory). The storage unit 103 also stores data, software, and the like, that are used by the information display apparatus 100. The storage unit 103 is usually built into a case. However, a removable memory card, a storage device connected from outside, or the like, may also be used as the storage unit 103. The storage unit 103 stores a keyword inputted by the user, and audio data, image data, character data, and the like, which are used when performing processing associated with the keyword.

The input unit 104 includes a keyboard and buttons, which enable user's input operation. In addition, the input unit 104 may also receive input from an external device such as a microphone and a camera. The user can register a keyword by use of this input unit 104.

The image display unit 105 includes an LCD (Liquid Crystal Display), and organic EL. The image display unit 105 displays image data, and the like, which are included in a broadcast signal received by the broadcast receiving unit 102.

The audio output unit 106 outputs audio data included in the broadcast signal received by the broadcast receiving unit 102. Although the audio output unit 106 is usually built into the case, it may also be placed outside the case. In this embodiment, although a reproduced sound is output from a speaker, it may also be output by use of a head phone, or the like. In another case, the reproduced sound may also be output by use of an external reproducing unit capable of audio output.

The control unit 107 includes a CPU, and operates according to a program stored in the storage unit 103 so as to control each unit. Further, the control unit 107 detects a keyword included in the broadcast signal received by the broadcast receiving unit 102. To be more specific, a broadcast signal of the digital broadcast includes, as additional information, information data about the broadcast program, which is text data. The control unit 107, therefore, detects the keyword by comparing a keyword stored in the storage unit 103 with the text data included in the broadcast signal. Moreover, the control unit 107 performs the control so that an image, audio, characters, and the like, are combined with an image, and audio, of the received broadcast program to display them on the screen. More specifically, if a keyword stored in the storage unit 103 is detected in a broadcast signal, image data, audio data, and character data, which are stored in the storage unit 103, are read out. Then, the image, the audio, and the characters are combined with an image, and audio, of the broadcast program. The combined image is output to the image display unit 105, and the combined audio is output to the audio output unit 106. This is how to perform the control. The control unit 107 reads out from the storage unit 103 information specifying the processing, and then achieves the combination according to the information.

Incidentally, in this embodiment, a description is given based on the assumption that a cellular phone is used as an information display apparatus. However, any information display apparatus, such as a television, a PHS (Personal Handy-phone System), a PDA (Personal Digital Assistant), and a PC (Personal Computer), may also be used so long as the information display apparatus can receive a broadcast signal and display the received broadcast.

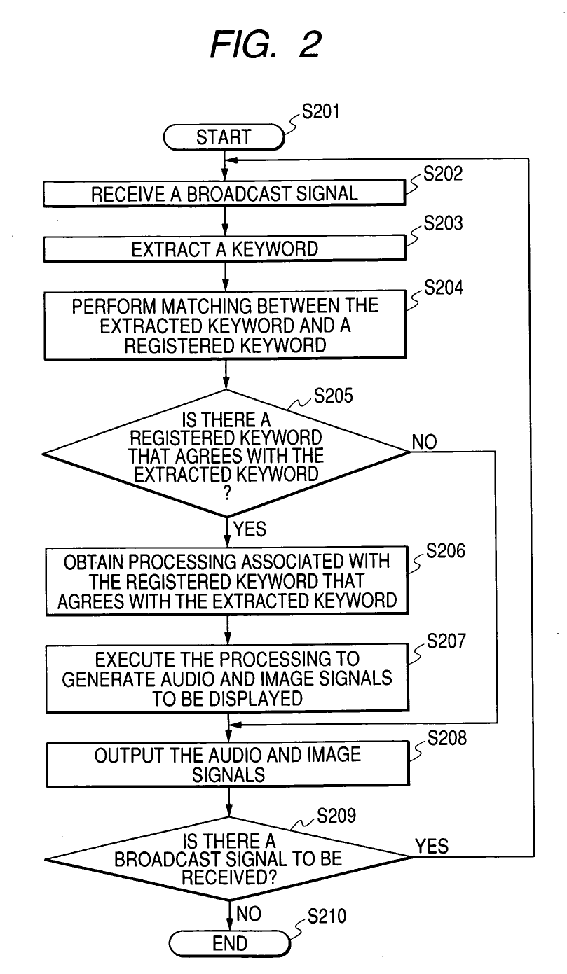

FIG. 2 is a flowchart illustrating processing steps of the information display apparatus according to this embodiment. When the processing is started (S201), the broadcast receiving unit 102 first receives a broadcast signal delivered from the broadcasting station (S202).

Next, the control unit 107 extracts a keyword relating to an image from information data included in the received broadcast signal (S203). The keyword is included in text data. The control unit 107 extracts the keyword included in this text data.

Next, matching is performed between the extracted keyword and the keyword registered in the storage unit 103 by the user (S204), and a judgment is then made as to whether or not there is a registered keyword that agrees with the extracted keyword (S205).

If a registered keyword that agrees with the extracted keyword is found, information about specified processing associated with the registered keyword is obtained from the storage unit 103 (S206) Then, the processing, the information of which has been obtained, is performed to generate audio and image signals to be displayed (S207). To be more specific, the control unit 107 combines image data, audio data, and character data, which are stored in the storage unit 103, with the received broadcast signal according to the obtained information about the processing, and thereby generates the audio and image signals. The control unit 107 then outputs the generated audio and image signals to the image display unit 105 and the audio output unit 106 (S208). On the other hand, if no registered keyword that agrees with the extracted keyword is found, the control unit 107 outputs the received broadcast signal just as it is as the audio and image signals to be displayed (S208).

Lastly, a judgment is made as to whether or not the broadcast signal is further being received (S209). If it is judged that the broadcast signal is still being received, the process returns to the step S202, and a series of the processing steps are repeated. If there is no broadcast signal to be received, the processing ends (S210).

Incidentally, this embodiment is based on the assumption that in the digital broadcast, the keyword is extracted from the information data that has been transmitted together with image data as a broadcast signal. However, any method may also be used so long as a keyword can be extracted, said method including: making use of text data of a teletext; performing voice recognition from audio in an image and thereby extracting a keyword; and identifying an image and thereby extracting a keyword. As a result, even if image information which does not always include text data is received, it becomes possible to extract a keyword. In addition, even if such image information is received, the user can enjoy the combined image.

Moreover, in this embodiment, the technique for extracting a keyword in real time was described. However, instead of extracting a keyword in real time, processing corresponding to a keyword may also be performed at the time specified by a table that lists the time at which a keyword is applied. This table is obtained from a broadcast signal or the Internet in advance.

Further, in this embodiment, the matching with the registered keyword is performed after extracting keywords from the broadcast signal. However, it may also be so devised that the matching is performed at the time of extracting the keywords so as to extract only a matched keyword.

Still further, this embodiment is based on the assumption that the information used for the matching with the registered keyword is only the keyword extracted from the broadcast signal. However, matching may also be performed between the registered keyword and a keyword that is specific to the information display apparatus, such as the time, a position, and a user name, and similar processing is performed thereafter. As a matter of course, using only any one of the keywords suffices. In this case, an assumed method of acquiring a position of the information display apparatus includes: acquiring the position by a GPS receiving unit (not illustrated); and acquiring the position by an area of a base station to be communicated.

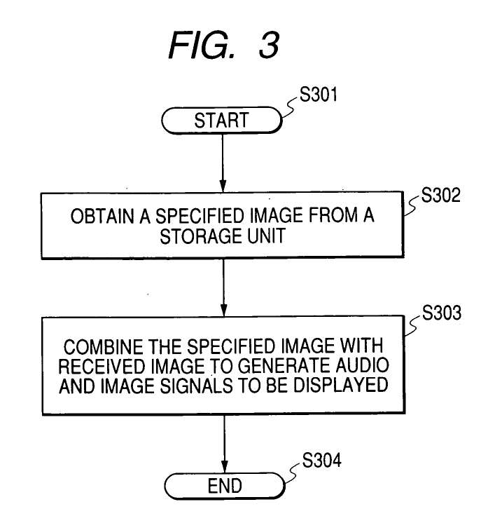

FIG. 3 is a flowchart illustrating specific processing steps of the step S207 shown in FIG. 2. In this embodiment, these processing steps are executed in a case where, if a registered keyword which agrees with the extracted keyword is found, specified operation associated with the registered keyword is to combine a specified image with an image. In a step S206 shown in FIG. 2, as soon as information about processing to be performed is obtained, the processing is started (S301). To begin with, a specified image is obtained from the storage unit (S302). Then, the obtained specified image is combined with an image that is being broadcasted, and consequently audio and image signals to be displayed are generated (S303), before the processing ends (S304). Next, the generated audio and image signals are output in the step S208.

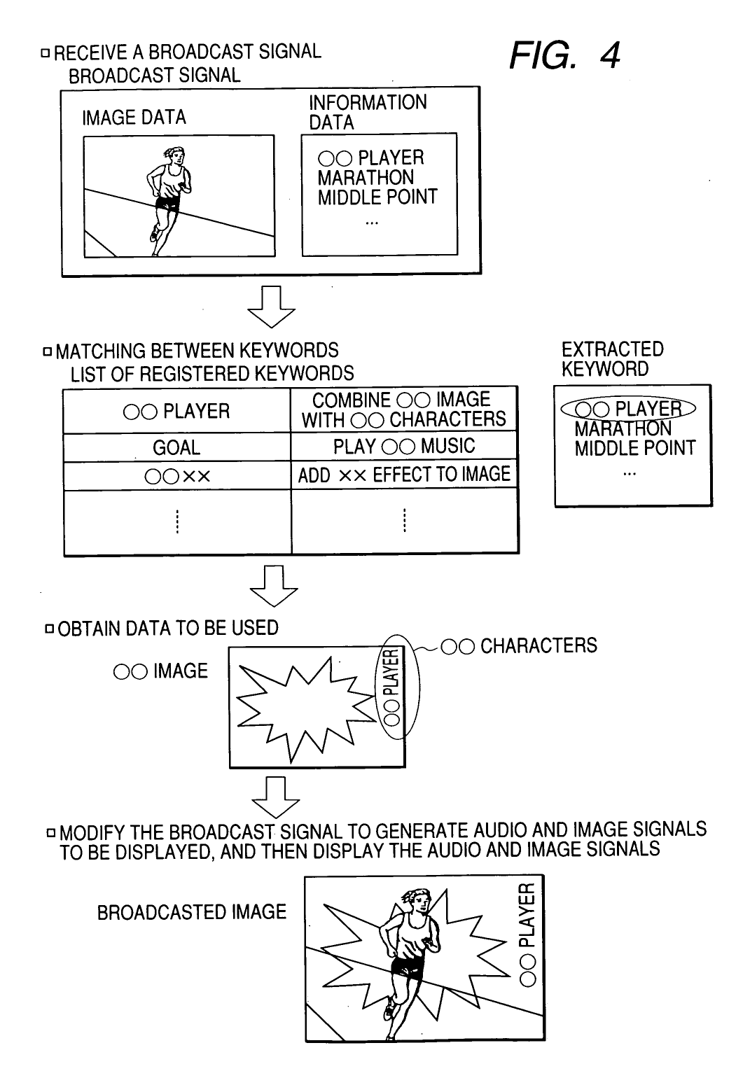

FIG. 4 is a drawing illustrating a process in which a specified image is combined with an image. A user registers in advance a “◯◯ player” as a registered keyword, and also registers, in advance, processing of “combining a ◯◯ image” as associated processing. As soon as an image is received, the control unit extracts a keyword that has been transmitted together with the image. In this example, keywords of “◯◯ player”, “marathon”, and “middle point” are included as information data. The control unit extracts these keywords. After that, matching is performed to check whether or not the “◯◯ player” stored in the storage unit is included in the extracted keywords. If an extracted keyword that agrees with the registered keyword is found, the control unit reads out from the storage unit “combining ◯◯ characters with ◯◯ image”, which is the stored processing associated with the “◯◯ player”, and also reads out from the storage unit the “◯◯ image” and the “◯◯ characters” that are specified. The control unit then combines the image and the characters with the received image to generate audio and image signals to be output. Then, on the basis of the generated audio and image signals, the image display unit displays the generated image, and the audio output unit outputs the generated audio. As a result, the user can customize the broadcast program so that his/her favorite player appears on the screen more effectively, and accordingly the user can view the broadcast program more enjoyably.

Incidentally, not only data that is preset beforehand in the storage unit, but also data stored by the user himself/herself may also be used as the image data, the audio data, and the character data, which are to be combined. For example, such data includes: an image that has been taken by the user himself/herself using a camera; audio that has been recorded using a microphone; and characters inputted by keys.

In addition, information downloaded from the Internet or the like may also be used as the image to be combined. For example, if there is a site, or the like, in which image data, audio data, and character data, are provided beforehand on a specific broadcast program basis, on a specific cast basis, or on a specific keyword basis, the data in question may also be downloaded and saved in the storage unit in advance. In this case, it may also be so devised that specific data is provided on a user basis, and the user is allowed to download only data required in response to user's favor.

As described above, various kinds of data required for the combination is saved in the storage unit; and if the data becomes necessary, reading out the data makes it possible to combine the data with the image, or the like, of the received broadcast. As a result, the user can view the broadcast program more enjoyably.

What was described in this embodiment is the case where the associated processing executed when a registered keyword agrees with an extracted keyword is the image combination. However, processing other than the image combination may also be executed. For example, the following processing may also be associated with an image that is being broadcasted: outputting specified music data; displaying specified character data; or specified image processing and audio modification processing. The image processing includes, for example: making the image monochrome or sepia; and adding a mosaic effect to the image. The audio modification processing includes: changing the musical interval of audio; and changing the audio to a constant sound. The following processing may also be executed: changing a channel; causing the image to pause; or the like. The use of a vibration function, switching on and off a lamp included in the information display apparatus, or the like, may also be associated. In addition, in this embodiment, the image data to be used was obtained from the storage unit. However, the data, and the like, used for the specified processing may also be obtained from a unit other than the storage unit. For example, the following may also be used: image data being inputted from a camera in the input unit; and image data and audio data which have been obtained from WEB. Moreover, as a matter of course, not only a still image but also a moving image and an animation may be used as image data that is used.

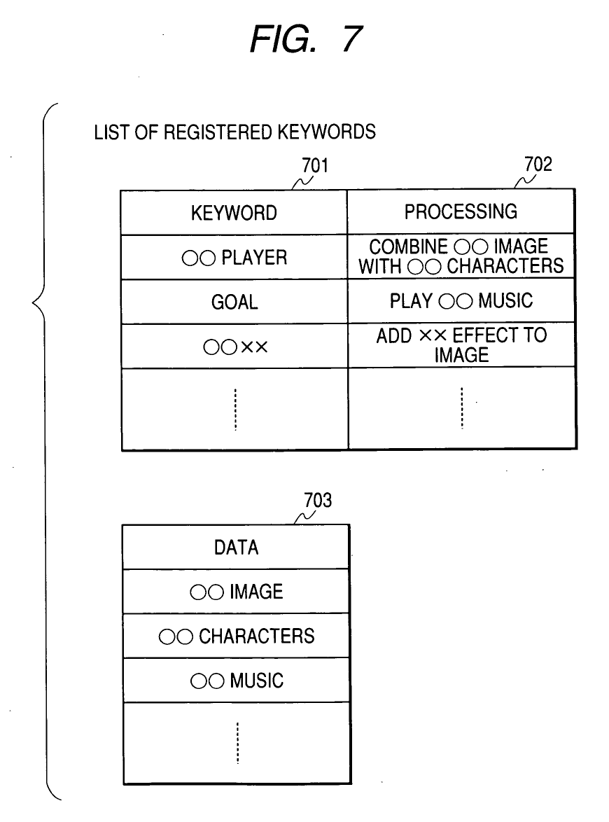

FIG. 7 illustrates as an example a list of processing 702 associated with registered keywords 701, and a list of data 703 to be used. The user uses the keys and the buttons to specify and set, in the information display apparatus, a keyword to be registered, its processing, and data that is used. The data that is used is obtained from an external storage device, WEB, the storage unit, or the like.

Further, the registered keyword may also be registered by combining a plurality of keywords. To be more specific, the keywords may also be combined by use of an And condition or an Or condition, such as “◯◯ and XX”, and “◯◯ or XX”. For example, if “◯◯ player” and “goal” are registered as keywords, processing associated with a scene in which the ◯◯ player made a goal is applied.

Further, the registered keyword may include not only a keyword extracted from a broadcast signal, but also user information about the information display apparatus, including the date and time, and a position. The user information may also be used for matching so that processing to be executed is determined.

In addition, although the processing described in this embodiment is executed when broadcasting the image that is being received from the broadcast receiving unit, the processing may also be executed for a recorded program obtained from the storage unit. In this case, as a matter of course, it may also be configured to have no broadcast receiving unit.

As a result, the user can view the program more enjoyably, for example, by decorating a scene of a favorite player, or a scene of a favorite entertainer, with a favorite image, or by adding favorite music to the scene. In another case, it is also possible to produce a realistic atmosphere by more effectively displaying a goal scene, and more effectively reproducing the music, while watching a sport program. In still another case, if the user does not want to view a specific scene, the user can enjoy the program by customizing the image and audio so that they suit his/her taste. The customization includes: changing a channel; adding a mosaic effect to a scene of an unfavorable entertainer, or to a scene that is not desirable for children; and causing a sound not to be heard.

Moreover, it may also be so devised that a registered keyword, processing associated with the registered keyword, and settings of data (including image data and audio data) required for the processing, can be obtained from outside. This enables the user to obtain various settings by use of the Internet and electronic mail without thinking about settings of complicated processing, and without searching an image to be used. To be more specific, heretofore users have to watch a broadcasted TV program just as it is, and accordingly the users cannot customize the program so that the program does not suit their own taste. However, according to this embodiment, the user can easily reproduce favorite image and favorite audio at a desired scene only by associating processing with a keyword. This enables the user to enjoy a program more effectively. As a result, it becomes possible to provide an information display apparatus having the enhanced usability, by which the user can enjoy.

### Second Embodiment

Next, a second embodiment will be described as below.

The first embodiment described the technique for combining the image received by the information processing device itself with data such as other images, audio, and characters. In the second embodiment, however, a image distributor registers beforehand a keyword on a user basis, and then combines information required by each user before transmitting the image to each user.

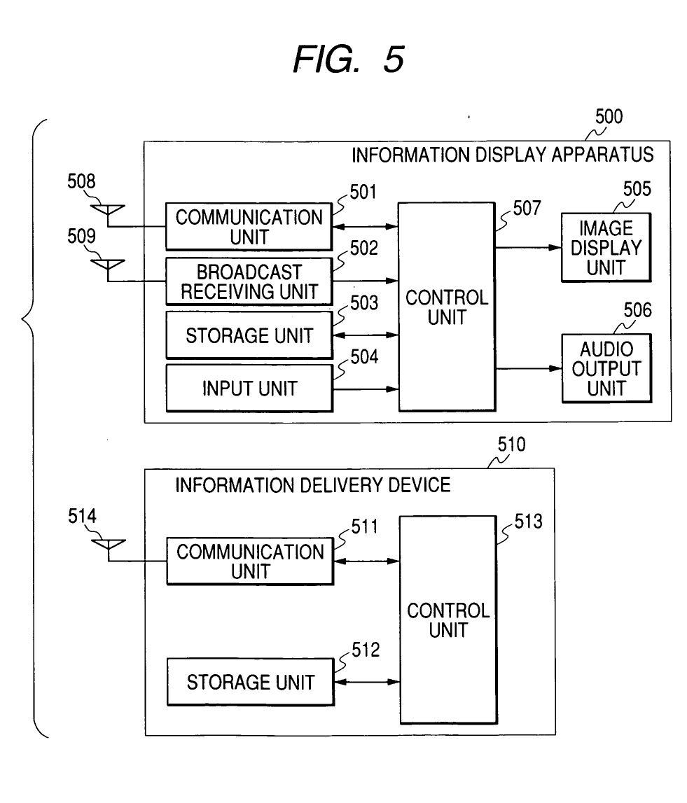

FIG. 5 is a diagram illustrating components of an information display apparatus as an information processing device according to this embodiment. An information display apparatus 500 as an information processing device includes a communication unit 501 for communicating with other terminals, external devices outside the terminals, information delivery devices, and the like, through an antenna 508; a broadcast receiving unit 502 for receiving broadcasts including television broadcasts and radio broadcasts through the antenna 509; a storage unit 503 for storing audio data including audio and music as well as image data including a still image and a moving image; an input unit 504 through which audio and an image are inputted, and through which the operation is performed; an audio output unit 506 for outputting audio data; and an image display unit 505 for displaying character data and image data; and a control unit 507 for controlling the above-mentioned units.

The information delivery device 510 includes the following: a communication unit 511 for communicating with other information display apparatuses, and the like, through the antenna 514; a storage unit 512 for storing audio data including audio and music, image data including a still image and a moving image, processing of delivering to the information display apparatus, and the like; and a control unit 513 for controlling the above-mentioned units.

Functions included in the information display apparatus 500 are similar to those in the first embodiment. However, in this embodiment, the communication unit 501 communicates with the other information display apparatuses and the external devices through the antenna 508, and in addition to it, the communication unit 501 transmits, to the information delivery device, a keyword specific to the information display apparatus, a keyword extracted from a broadcast signal that is being viewed. Additionally, the storage unit is used only for storing software, or the like. Accordingly, it is not necessary to store audio data, image data, and character data that are used when setting and executing a keyword, and processing associated with the keyword, registered by the user.

The communication unit 511 of the information delivery device 510 communicates with other information display apparatuses, external devices, and the like, through the antenna 514. This enables communication through the Internet. Moreover, a keyword transmitted from the information display apparatus, a keyword to be registered, processing to be registered, and the like, are received.

The storage unit 512 includes, for example, a ROM (Read Only Memory), and a RAM (Random Access Memory). The storage unit 512 also stores data, software, and the like, that are used by the information delivery device 510. The storage unit 512 is usually built into a case. However, a removable memory card, a storage device connected from outside, or the like, may also be used as the storage unit 512. The storage unit 512 also stores a setting list of processing associated with a registered keyword, and also stores audio data, image data, and character data, which are used when executing the processing.

The control unit 513 includes a CPU, and operates according to a program stored in the storage unit 512 so as to control each unit.

In this embodiment, the information display apparatus and the information delivery device are configured on the assumption that the communication unit communicates through a base station. However, they may also be configured to directly communicate using a wireless system. It is to be noted that the number of information display apparatuses which communicate with one information delivery device may be more than one.

In this embodiment, a description is given based on the assumption that a cellular phone is used as the information display apparatus 500. However, any information display apparatus, such as a television, a PHS (Personal Handy-phone System), a PDA (Personal Digital Assistant), and a PC (Personal Computer), may also be used so long as the information display apparatus 500 can receive a broadcast signal and display the received broadcast.

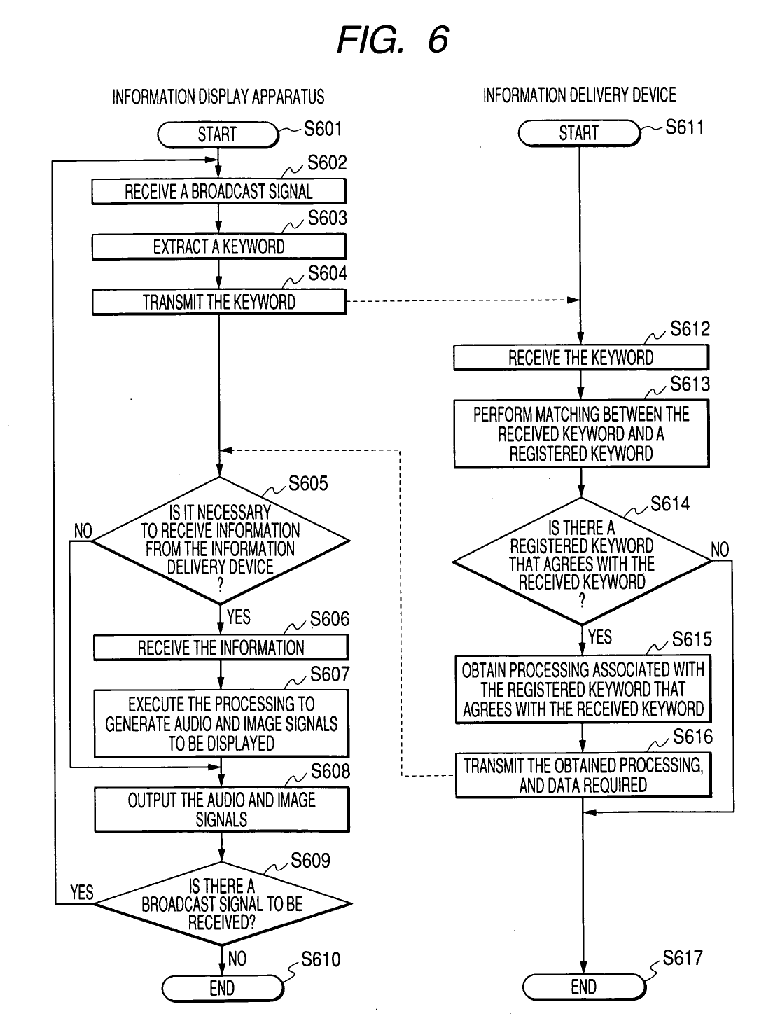

FIG. 6 is a flowchart illustrating processing steps of the information display apparatus and the information delivery device according to this embodiment. In the information display apparatus, when the processing is started (S601), the broadcast receiving unit 502 first receives a broadcast signal delivered from the broadcasting station (S602). Next, the control unit 507 extracts a keyword relating to an image from information data included in the received broadcast signal (S603). After that, the keyword extracted from the broadcast signal, a keyword which is specific to the information display apparatus, and the like, are transmitted from the communication unit 501 to the information delivery device 510 (S604).

When the processing is started in the information delivery device (S611), the communication unit 511 receives the keyword which has been extracted from the broadcast signal transmitted from the information display apparatus, the keywords which is specific to the information display apparatus, and the like (S612). Matching is performed between the received keyword and the registered keyword that is registered in the setting list stored in the storage unit 512 (S613), and then a judgment is made as to whether or not there is a registered keyword that agrees with the received keyword (S614). If a registered keyword that agrees with the received keyword is found, specified processing associated with the keyword, and data required to execute the specified processing, are obtained for the storage unit 513 (S615), and are then transmitted to the information display apparatus (S616), before ending the processing (S617). If no keyword that agrees with the received keyword is found, nothing is transmitted before ending the processing (S617).

The information display apparatus makes a judgment as to whether or not to communicate with the information delivery device (S605). If it is judged that the information display apparatus needs to communicate with the information delivery device, the information display apparatus receives information, including transmitted processing and data that is used (S606), and then executes the processing to generate audio and image signals to be displayed (S607). The information display apparatus outputs the generated audio and image signals to the image display unit 505 and the audio output unit 506 (S608). If it is not necessary to communicate with the information delivery device, the information display apparatus outputs the broadcast signal, which has been received by the broadcast receiving unit, just as it is as audio and image signals (S608). Next, a judgment is made as to whether or not the broadcast signal is further being received (S609). If it is judged that the broadcast signal is still being received, the process returns to the step S602, and a series of the processing steps are repeated. If the user stops watching the broadcast and consequently there is no broadcast signal to be received, the processing ends (S610). As is the case with the first embodiment, as for the extraction method for extracting a keyword from a broadcast signal in the information display apparatus, any kind of method may be used.

As keyword information which is extracted from a broadcast signal and then transmitted to the information delivery device, any information may be used, including: a television channel being watched; a television program name; a cast; names of people, names of commodities, which are currently displayed; and information expressing a scene. In addition, as keywords specific to the information display apparatus, any information may be used, including a terminal ID, and a user name, a telephone number, an electronic mail address, the distinction of sex, the date and time, and a position. Moreover, only either of the keyword extracted from the broadcast signal, or the keyword specific to the information display apparatus may be used as information to be transmitted to the information delivery device. In this case, an assumed method of acquiring a position of the information display apparatus includes: acquiring the position by a GPS receiving unit that is not illustrated; and acquiring the position by an area of a base station to be communicated.

Further, in this embodiment, the information delivery device obtained from the storage unit the image data to be used. However, the data, and the like, used for the specified processing may also be obtained from a unit other than the storage unit. For example, the following may also be used: image data being inputted from a camera in the input unit; and image data and audio data which have been obtained from WEB. Moreover, as a matter of course, not only a still image but also a moving image and an animation may also be used as image data that is used.

Further, the registered keyword can also be registered by combining a plurality of keywords. The combination includes “◯◯ and XX”, and “◯◯ or XX”. For example, if “◯◯ player” and “12:00-13:00” are registered as keywords, when the ◯◯ player appears at 12:30, processing associated with the scene is applied.

In addition, although the processing described in this embodiment is executed when broadcasting the image which the information display apparatus is receiving from the broadcast receiving unit, the processing may also be executed for a recorded program obtained from the storage unit. In this case, as a matter of course, it may also be configured to have no broadcast receiving unit.

As described above, FIG. 7 illustrates as an example a list of processing 702 associated with registered keywords 701, and a list of data to be used 703. The user uses the keys and the buttons to specify a keyword to be registered 701, its processing 702, and data to be used 703, and then to transmit a setting list to the information delivery device, and to save the setting list in the storage unit of the information delivery device. The transmission processing 702, and the data to be used 703, may also be obtained from WEB, an external device, the storage unit, or the like. It may also be so devised that the setting list is simultaneously kept in the information display apparatus, and only settings required by the information delivery device are selected and transmitted. In another case, the user sets only a keyword in the information display apparatus. Because a cellular phone is usually in a state of waiting, associated processing, and data to be used, may also be automatically downloaded and updated in advance by an external device such as the information delivery device. As a matter of course, the associated processing, and the data to be used, may also be downloaded by manual operation. In like manner, the registered keyword may also be obtained from outside. As a matter of course, also in the first embodiment, it is also possible to obtain the registered keyword from outside in like manner.

In another case, the settings stored in the storage unit of the information delivery device can be changed and updated by user's operation, instructions of which are transmitted from the information display apparatus, or by means of operation other than the user's operation. The settings may also be automatically changed or updated in response to the date and time, weather information, user information, and the like. This makes it possible to display information in response to user's points, to present information in response to the number of times commercials are displayed, and to present information in response to the date and time, and further to cause the displayed and presented information to be automatically changed. As a result, information suitable for each individual is displayed without settings by the user.

In this embodiment, the information display apparatus transmits all of the keywords extracted from a broadcast signal, and all of the information specific to the information display apparatus, to the information delivery device so that the information delivery device performs matching, and selects corresponding processing if there is a keyword that agrees with the registered keyword. However, it may also be so devised that the information display apparatus stores the registered keywords, and judges whether or not there is a registered keyword that agrees with the extracted keyword or the keyword specific to the information display apparatus, and then transmits to the information delivery device only a keyword that agrees with it. This makes it possible to reduce the load of the matching process in the information delivery device.

Further, in this embodiment, the matching with the registered keyword is performed after extracting keywords from the broadcast signal. However, it may also be so devised that the matching is performed at the time of extracting the keywords so as to extract only a matched keyword.

In this embodiment, if in the information delivery device there is no registered keyword that agrees with the extracted keyword, nothing is transmitted to the information display apparatus before the processing ends. However, it may also be so devised that what is transmitted to the information display apparatus is information indicating that there is no registered keyword that agrees with the extracted keyword, and that if the information display apparatus receives information indicating that nothing is to be performed, the information display apparatus displays a broadcast signal just as it is as audio and image signals without performing processing.

In addition, in this embodiment, data used for processing is stored in the storage unit of the information delivery device, and if the extracted keyword agrees with the registered keyword, not only processing but also the data used for the processing is transmitted. However, it may also be so devised that data used for processing is stored in, for example, a storage unit of the information display apparatus, and the data is used at the time of the processing.

Moreover, the information display apparatus extracts keywords from a broadcast signal in this embodiment. However, the information delivery device may directly receive a broadcast signal so that the information delivery device extracts keywords.

Thus, individual function may be performed by any one of the information display apparatus and the information delivery device.

Further, in a cable television broadcast, a broadcasting station may also be configured as the information delivery device.

In addition, the user is allowed to select or switch: performing the above-mentioned processing offline as described in the first embodiment: or performing the processing through the information delivery device as described in the second embodiment. The above-mentioned processing may also be automatically switched.

Furthermore, it is also possible to set whether to perform the processing in the information display apparatus so that, for example, when the remaining quantity of a battery becomes low, the processing is automatically omitted.

As a result of the configuration described above, display method and displayed information are automatically changed in response to information by updating the information on the company side, or by automatically changing the information by use of the information delivery device, without allowing users to change and update images such as commercials. Accordingly, the users can easily reproduce image and audio, which are suitable for each individual, at a desired scene. This enables the users to enjoy a program more effectively. As a result, it becomes possible to provide an information display apparatus having the enhanced usability, by which the user can enjoy.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

1. An information processing device capable of receiving a television broadcast, said information processing device comprising:
a broadcast receiving unit for receiving a television broadcast;
a display unit for displaying an image of the television broadcast received by the broadcast receiving unit;
an input unit for inputting a keyword;
a storage unit for storing the keyword, and data associated with the keyword; and
a control unit for controlling the broadcast receiving unit, the display unit, the input unit, and the storage unit;
wherein
if the keyword is included in the television broadcast received by the broadcast receiving unit, said control unit controls the display unit so that the image of the television broadcast and the data associated with the keyword are combined before displaying the image and the data.

2. An information processing device capable of receiving a television broadcast, said information processing device comprising:
a broadcast receiving unit for receiving a television broadcast;
an audio output unit for outputting audio of the television broadcast received by the broadcast receiving unit;
an input unit for inputting a keyword;
a storage unit for storing the keyword, and data associated with the keyword; and
a control unit for controlling the broadcast receiving unit, the audio output unit, the input unit, and the storage unit;
wherein
if the keyword is included in the television broadcast received by the broadcast receiving unit, said control unit controls the audio output unit so that the audio of the television broadcast and the data associated with the keyword are combined before outputting the audio and the data.

3. An information processing device according to claim 1, further comprising:
a communication unit for performing data communications, wherein said data associated with the keyword is data received by the communication unit.

4. An information processing device according to claim 1, wherein
said data associated with the keyword is data entered by a user.

5. An information processing device according to claim 1, wherein said data associated with the keyword is image data, audio data, or character data.

6. An information processing device according to claim 1, wherein said data associated with the keyword includes data that specifies processing performed at the time of the combination.

7. An information processing device capable of receiving a television broadcast, said information processing device comprising:
a broadcast receiving unit for receiving a television broadcast;
an input unit for inputting a keyword;
a storage unit for storing the keyword, and data associated with the keyword; and
a control unit for controlling the broadcast receiving unit, the input unit, and the storage unit;
wherein
if the keyword is included in a signal of the television broadcast received by the broadcast receiving unit, said control unit outputs a signal into which the signal of the television broadcast and a signal of the data associated with the keyword are combined.

8. An information processing device capable of receiving a television broadcast, said information processing device comprising:
a broadcast receiving unit for receiving a television broadcast;
a display unit for displaying an image of the television broadcast received by the broadcast receiving unit;
an input unit for inputting a keyword;
a storage unit for storing the keyword, and data associated with the keyword; and
a control unit for controlling the broadcast receiving unit, the display unit, the input unit, and the storage unit;
wherein
if the keyword is included in the television broadcast received by the broadcast receiving unit, said control unit controls the display unit so that the image of the television broadcast and the data associated with the keyword are displayed on the same screen.

9. An information processing system comprising an information processing device and an information delivery device, wherein
said information processing device comprises:
a broadcast receiving unit for receiving a television broadcast;
a communication unit for communicating with the information delivery device;
a display unit for displaying image of the television broadcast received by the broadcast receiving unit;
an input unit for inputting a keyword;
a storage unit for storing the keyword, and data associated with the keyword; and
a control unit for controlling the broadcast receiving unit, the communication unit, the display unit, the input unit, and the storage unit; wherein
if the keyword is included in the television broadcast received by the broadcast receiving unit, said control unit controls the display unit so that the image of the television broadcast and the data associated with the keyword are combined before displaying the image and the data; and
said information delivery device comprises:
a communication unit for receiving a keyword transmitted from the information processing device; and
a storage unit for storing the keyword, and data associated with the keyword; wherein
said communication unit transmits, to the information processing device, the data associated with the keyword.
